(19) United States
(12) Patent Application Publication
(10) Pub. No.: US 2009/0039054 A1
(43) Pub. Date: Feb. 12, 2009

(54) ETCHING APPARATUS OF GLASS SUBSTRATE FOR FLAT PANEL DISPLAY AND METHOD OF ECTCHING GLASS SUBSTRATE FOR FLAT PANEL DISPLAY USING THE SAME

(75) Inventors: Ho-Geun CHOI, Suwon-si (KR); Yong-Woo KIM, Hwaseong-si (KR); Myoung-Ki LEE, Hwaseong-si (KR); Pal-Kon KIM, Cheonan-si (KR)

Correspondence Address: CANTOR COLBURN, LLP, 20 Church Street, 22nd Floor, Hartford, CT, 06103, US

(73) Assignee: Samsung Electronics Co., Ltd., Suwon-si (KR)

(21) Appl. No.: 12/100,793

(22) Filed: Apr. 10, 2008

(30) Foreign Application Priority Data
Apr. 10, 2007 (KR) 10-2007-0035108

(51) Int. Cl. B29D 11/00; C03C 15/00

(52) U.S. Cl. 216/24; 156/345.21

(57) ABSTRACT

An etching apparatus of a glass substrate for a flat panel display includes an etching chamber configured to receive a jig, glass substrates disposed on the jig, a holding member connected to the jig to hold the glass substrates, a transferring line connected to the jig to transfer the jig into the etching chamber, and a spray member which sprays an etchant onto surfaces of the glass substrates. A spray pressure of the etchant is equal to or greater than approximately 0.1 kg/cm² and is less than approximately 0.5 kg/cm².

This application claims priority to Korean Patent Application No. 2007-35108, filed on Apr. 10, 2007, and all the benefits accruing therefrom under 35 U.S.C. § 119, the contents of which in its entirety are herein incorporated by reference.

### BACKGROUND OF THE INVENTION

1. Field of the Invention

The present invention relates to an etching apparatus of a glass substrate for a flat panel display. More particularly, the present invention relates to an etching apparatus having a reduced etching process time and an improved uniformity of the glass substrate.

2. Description of the Related Art

A flat panel display such as a liquid crystal display, a plasma display panel, an electroluminescent display and a vacuum fluorescent display, for example, is widely used in various electronic devices. In order to use the flat panel display in a mobile electronic device such as a mobile phone or a personal digital assistant, for example, the flat panel display is required to have desirable properties therefor, e.g., being thin and light weight. To that end, research and development has been directed toward a glass substrate component of the mobile electronic device having a reduced, e.g., light, weight.

In a case in which a thin glass substrate is employed to reduce a weight of the glass substrate, however, the thin glass substrate is easily bent or cracked. Further, when a flat panel display having the thin glass substrate is assembled using a number of the small glass substrates, for example, a manufacturing cost of the flat panel display thereby increases.

Thus, a method in which several flat panel displays are fabricated on a pair of large glass substrates, wherein the large glass substrates are cut into smaller glass substrates according to regions in which the flat panel displays are to be respectively fabricated is used to reduce the manufacturing cost. In this fabrication process, however, an etching apparatus is needed to etch the smaller glass substrates to a specific desired thickness, since the smaller glass substrates must have a sufficient thickness to prevent the smaller glass substrates from being cracked during the fabrication process.

According to an etching apparatus of the prior art, however, the large glass substrates are transferred into the etching apparatus using a supporting member, and, as a result, only one glass substrate can be etched at one time. Also, since the etching apparatus employs only one transferring line, a manufacturing productivity is thereby decreased.

Further, in a case in which the glass substrate has an uneven etching surface, a spray apparatus is located proximate to the glass substrate to apply etchant to the glass substrate. However, a region of the glass substrate corresponding to a location of a spray nozzle from which the etchant is sprayed at a high force is etched differently, e.g., to a different thickness, of a region of the glass substrate corresponding to another spray nozzle from which the etchant is sprayed at a lower force. As a result, a uniformity of the glass substrate is reduced, and the glass substrate is not evenly etched.

### BRIEF SUMMARY OF THE INVENTION

The present invention includes an etching apparatus of a glass substrate capable of simultaneously etching more than one glass substrate, thereby providing a reduced etching process time for the glass substrate and an improved uniformity of a thickness of the glass substrate.

In an exemplary embodiment of the present invention, an etching apparatus of a glass substrate for a flat panel display includes an etching chamber, a jig at which plural glass substrates are settled, a holding member connected to the jig to hold the glass substrates, a transferring line connected to the jig to transfer the jig into the etching chamber, and a spray member which sprays an etchant onto surfaces of the glass substrates. A spray pressure of the etchant is equal to or greater than approximately 0.1 kg/cm² and is lower than approximately 0.5 kg/cm².

The spray member may be disposed in the etching chamber, and the spray member may include a nozzle which rotates in a clockwise direction and/or a counter clockwise direction.

The etching apparatus may further include a driving part connected to the etching chamber to move the etching chamber.

The etchant includes one of a fluoric acid, a phosphoric acid and a nitric acid, and a distance between the spray member and the glass substrates is greater than approximately 100 mm and is equal to or less than approximately 150 mm. In an alternative exemplary embodiment, the distance between the spray member and the glass substrates is approximately 120 mm.

The holding member includes a rear holding pin connected to a rear surface of at least one of the glass substrates, and a rotatable front holding pin connected to a front surface of the at least one of the glass substrates.

The rotatable front holding pin has a structure which is detachable from and/or attachable to the holding member.

In an alternative exemplary embodiment, a method for etching a glass substrate for a flat panel display includes: configuring an etching chamber to receive a jig; disposing glass substrates on the jig; connecting a holding member to the jig to hold the glass substrates; transferring the jig into the etching chamber with a transferring line connected to the jig; and spraying an etchant onto surfaces of the glass substrates with a spray member. A spray pressure of the etchant is equal to or greater than approximately 0.1 kg/cm² and is less than approximately 0.5 kg/cm².

The spraying the etchant onto the surfaces of the glass substrates may include rotating a nozzle in at least one of a clockwise direction and a counter clockwise direction.

The method may further include connecting a driving part to the etching chamber, and moving the etching chamber with the driving part.

A distance between the spray member and the glass substrates is greater than approximately 100 mm and is equal to or less than approximately 150 mm. In yet another alternative exemplary embodiment, the distance between the spray member and the glass substrates is approximately 120 mm.

The etchant may include one of a fluoric acid, a phosphoric acid and a nitric acid.

### BRIEF DESCRIPTION OF THE DRAWINGS

The above and other aspects, features and advantages of the present invention will become more readily apparent by describing in further detail exemplary embodiments thereof with reference to the accompanying drawings, in which:

FIG. 1A is a side perspective view of an etching apparatus according an exemplary embodiment of the present invention;

FIG. 1B is a partial cross-sectional side view of the etching apparatus according to the exemplary of the present invention shown in FIG. 1A;

FIG. 2A is a side plan view of a jig of the etching apparatus according to the exemplary of the present invention shown in FIG. 1A;

FIG. 2B is an enlarged view of portion “FM” in FIG. 2A;

FIG. 3 is a partial cross-sectional side view of an etching apparatus according to an alternative exemplary embodiment of the present invention;

FIGS. 4A, 5A and 6A are side perspective views of an etching apparatus according to yet another alternative exemplary embodiment of the present invention;

FIGS. 4B, 5B and 6B are partial cross-sectional side views of the etching apparatus according to the alternative exemplary of the present invention shown in FIGS. 4A, 5A and 6A, respectively;

FIGS. 7A, 8A and 9A are side perspective views of an etching apparatus according to still another alternative exemplary embodiment of the present invention; and

FIGS. 7B, 8B and 9B are partial cross-sectional side views of the etching apparatus according to the alternative exemplary of the present invention shown in FIGS. 7A, 8A and 9A, respectively.

### DETAILED DESCRIPTION OF THE INVENTION

The invention will now be described more fully hereinafter with reference to the accompanying drawings, in which exemplary embodiments of the invention are shown. The present invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including,” when used in this specification, specify the presence of stated features, regions, integers, steps, operations, elements and/or components, but do not preclude the presence or addition of one or more other features, regions, integers, steps, operations, elements, components and/or groups thereof.

Furthermore, relative terms, such as “lower” or “bottom” and “upper” or “top” may be used herein to describe one element's relationship to other elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on the “upper” side of the other elements. The exemplary term “lower” can, therefore, encompass both an orientation of “lower” and “upper,” depending upon the particular orientation of the figure. Similarly, if the device in one of the figures were turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning which is consistent with their meaning in the context of the relevant art and the present disclosure, and will not be interpreted in an idealized or overly formal sense unless expressly so defined herein.

Exemplary embodiments of the present invention are described herein with reference to cross section illustrations which are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes which result, for example, from manufacturing. For example, a region illustrated or described as flat may, typically, have rough and/or nonlinear features. Moreover, sharp angles which are illustrated may be rounded. Thus, the regions illustrated in the figures are schematic in nature and their shapes are not intended to illustrate the precise shape of a region and are not intended to limit the scope of the present invention.

Hereinafter, exemplary embodiments of the present invention will be described in further detail with reference to the accompanying drawings.

In fabricating a flat panel display, for example, a pair of glass substrates includes a first glass substrate having a transparent electrode formed using a transparent conductive layer such as indium tin oxide, a driving electrode formed using a low temperature polysilicon by a chemical vapor deposition process, and a common electrode. A second glass substrate of the pair of glass substrates includes a color filter formed thereon.

The transparent electrode, the driving electrode and the common electrode of the first glass substrate are formed by a photolithography process, for example, which includes an exposure process, a development process, and an etch process.

After the photolithography process, a sealant is coated onto a peripheral portion of either the first glass substrate or the second glass substrate, a liquid crystal is injected into a region defined by, e.g., surrounded by, the sealant on the peripheral portion of the either the first glass substrate or the second glass substrate, a spacer is formed on either the first glass substrate or the second glass substrate, and the other glass substrate, e.g., either the first glass substrate or the second glass substrate on which the sealant is not coated, is coupled to the either the first glass substrate or the second glass substrate on which the sealant is coated.

Next, an etching process is performed to etch outer surfaces of the first glass substrate and the second glass substrate. To perform the etching process, the first glass substrate and the second glass substrate are both held by a jig, and the first glass substrate and the second glass substrate each move along a transferring line while being supported in a vertically position by the jig. When the first glass substrate and the second glass substrate are then loaded into an etching apparatus, an etchant is sprayed onto the outer surfaces to etch the first glass substrate and the second glass substrate.

The etching apparatus may include an inlet unit, an etching unit, a cleaning unit, a drying unit and an outlet unit, and a number of each of the abovementioned units may be varied according to a desired installation and/or manufacturing configuration.

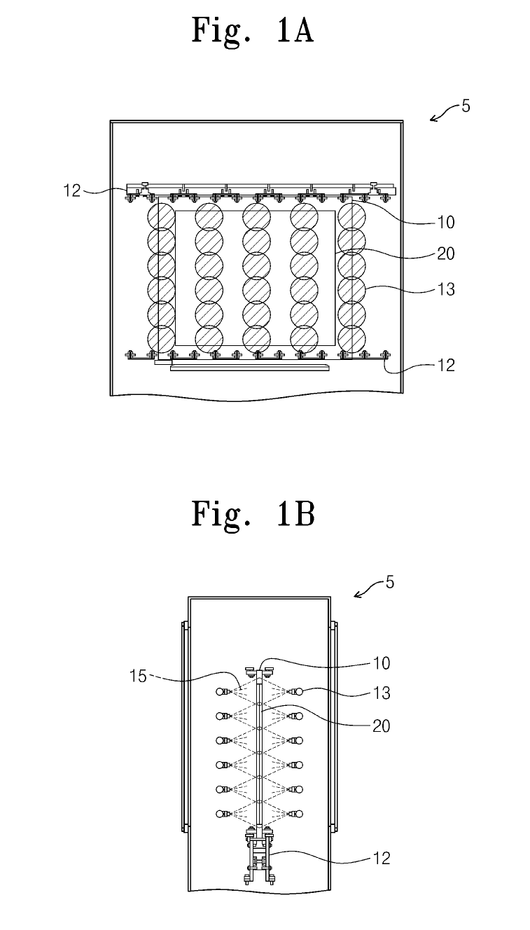

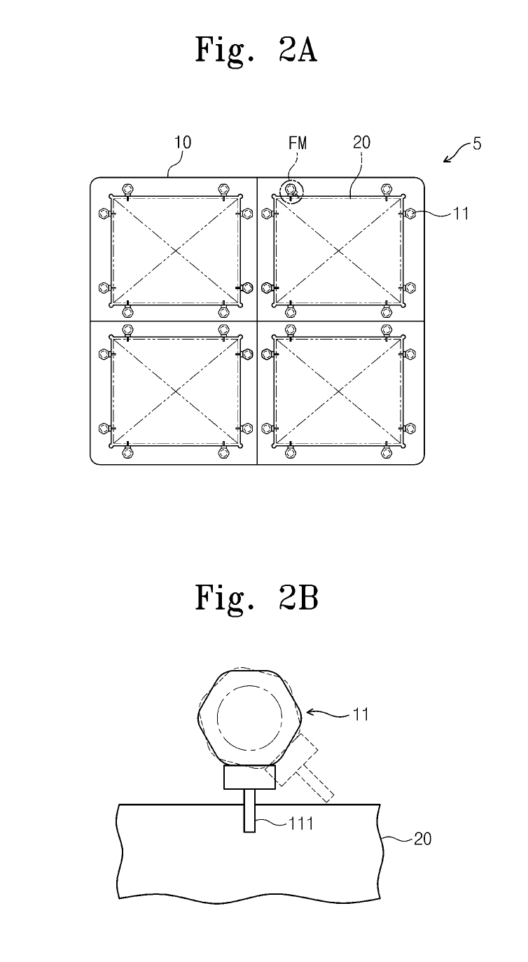

FIG. 1A is a side perspective view of an etching apparatus according to an exemplary embodiment of the present invention, and FIG. 1B is a partial cross-sectional side view of the etching apparatus according to the exemplary of the present invention shown in FIG. 1A.

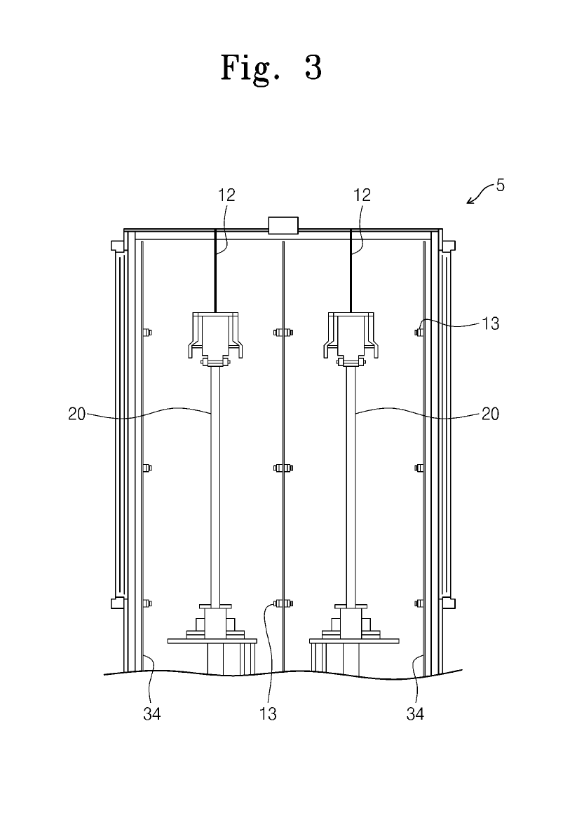

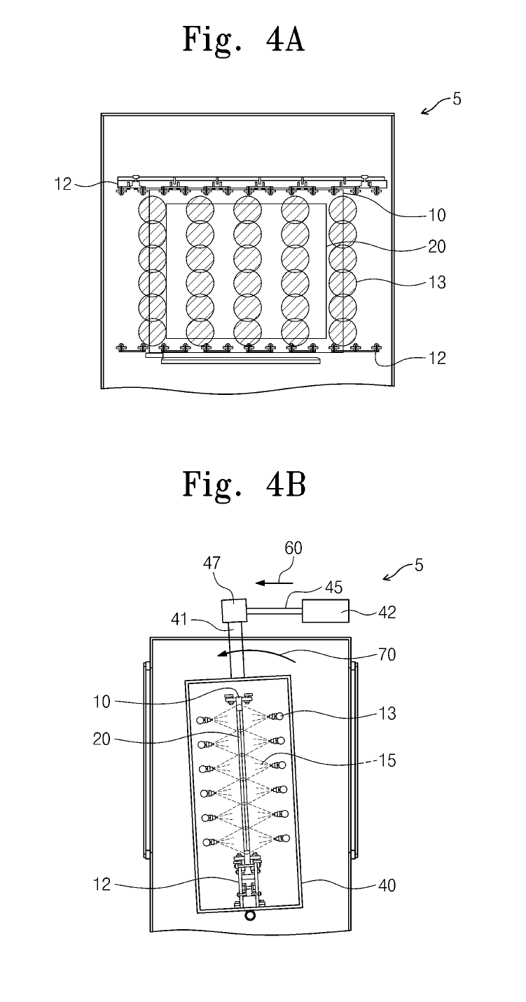

Referring to FIGS. 1A and 1B, an etching apparatus 5 includes a jig 10 including a holding member 11 (FIG. 2A) to hold a glass substrate 20, a spray member 13 which sprays an etchant 15 onto the glass substrate 20, and a transferring line 12 which transfers, e.g., moves, the jig 10 which holds the glass substrate 20 with the holding member 11. In an alternative exemplary embodiment, the jig 10 may hold more than one glass substrate 20, e.g., the jig 10 may hold glass substrates 20. In addition, in an exemplary embodiment of the present invention the etchant 15 is a fluoric acid, but alternative exemplary embodiments are not limited thereto. For example, in an alternative exemplary embodiment, the etchant 15 may be a phosphoric acid or a nitric acid, for example.

As shown in FIG. 1B, the jig 10 holds the glass substrates 20 substantially upright, e.g., aligned vertically within the etching apparatus 5. When the etchant 15 is sprayed from the spray member 13 onto the glass substrates 20, the glass substrates 20 are etched.

FIG. 2A is a side plan view of the jig 10 of the etching apparatus 5 according to the exemplary of the present invention shown in FIG. 1A, and FIG. 2B is an enlarged view of portion “FM” in FIG. 2A.

Referring to FIGS. 2A and 2B, the jig 10 includes the holding member 11, which holds the glass substrates 20. In the exemplary embodiment shown in FIG. 2A, for example, four glass substrates 20 are held by the jig 10, but alternative exemplary embodiments are not limited thereto. Rather, a number of the glass substrates 20 held by the jig 10 may be varied based on a size, for example, of the glass substrates 20. As described in greater detail above, when more than one of the glass substrates 20 are installed on the jig 10, each of the glass substrates 20 is etched at once, and a productivity of a flat panel display, for example, having the glass substrates 20 is thereby substantially improved or effectively increased.

In an exemplary embodiment the holding member 11 of the jig includes a rear holding pin (not shown) which is not movable and a front holding pin 111 which is movable. As shown in FIG. 2B, the front holding pin 111 is rotated as shown by a dotted line and thus deviates from a position where the glass substrates 20 are received when the glass substrates 20 are received into the jig 10. The front holding pin 111 then returns its original position as shown in a solid line in FIG. 2B. Thus, the glass substrates 20 are held by the rear holding pin (not shown) and the front holding pin 111. In an exemplary embodiment, the rear holding pin and the front holding pin 111 include structure which is detachable from and/or attachable to the holding member 11.

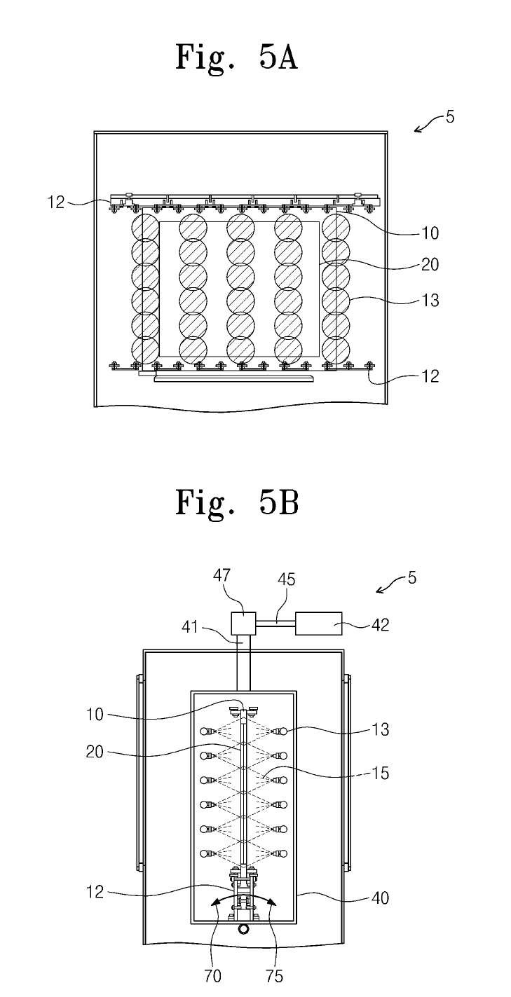

FIG. 3 is a partial cross-sectional side view of an etching apparatus according to an alternative exemplary embodiment of the present invention.

Referring to FIG. 3, the etching apparatus 5 may include a plurality of transferring lines 12. For example, in the exemplary embodiment of the present invention shown in FIG. 3, the etching apparatus 5 includes two transferring lines 12, but alternative exemplary embodiments are not limited thereto. When the etching apparatus 5 includes the plurality of transferring lines 12, a path of a given number of the glass substrates 20 through the etching apparatus 5 is effectively shortened, and a smaller etching apparatus 5 thereby etches the same number glass substrates 20. Further, since the etchant 15 may be supplied to the spray member 13 disposed between the glass substrates 20 using one etchant supply line 34, a manufacturing cost of the etching apparatus is thereby reduced.

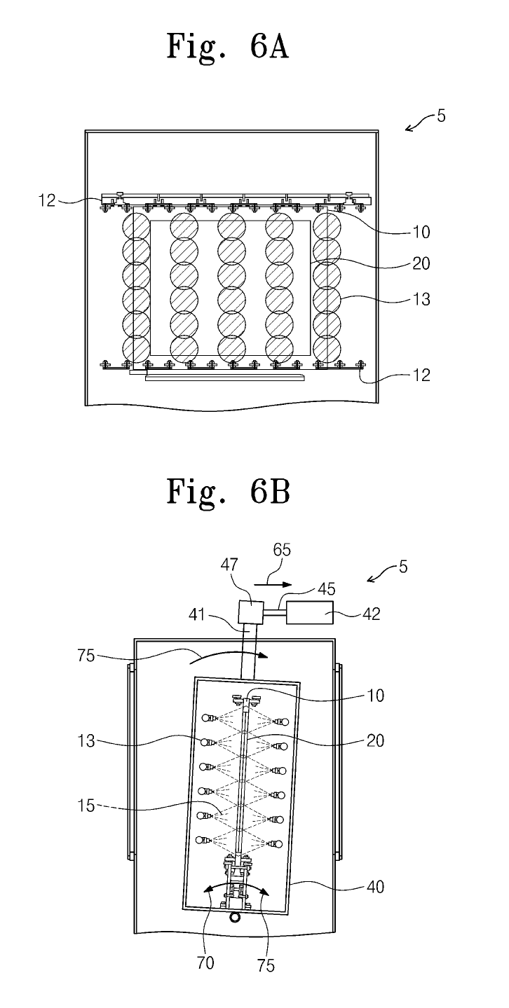

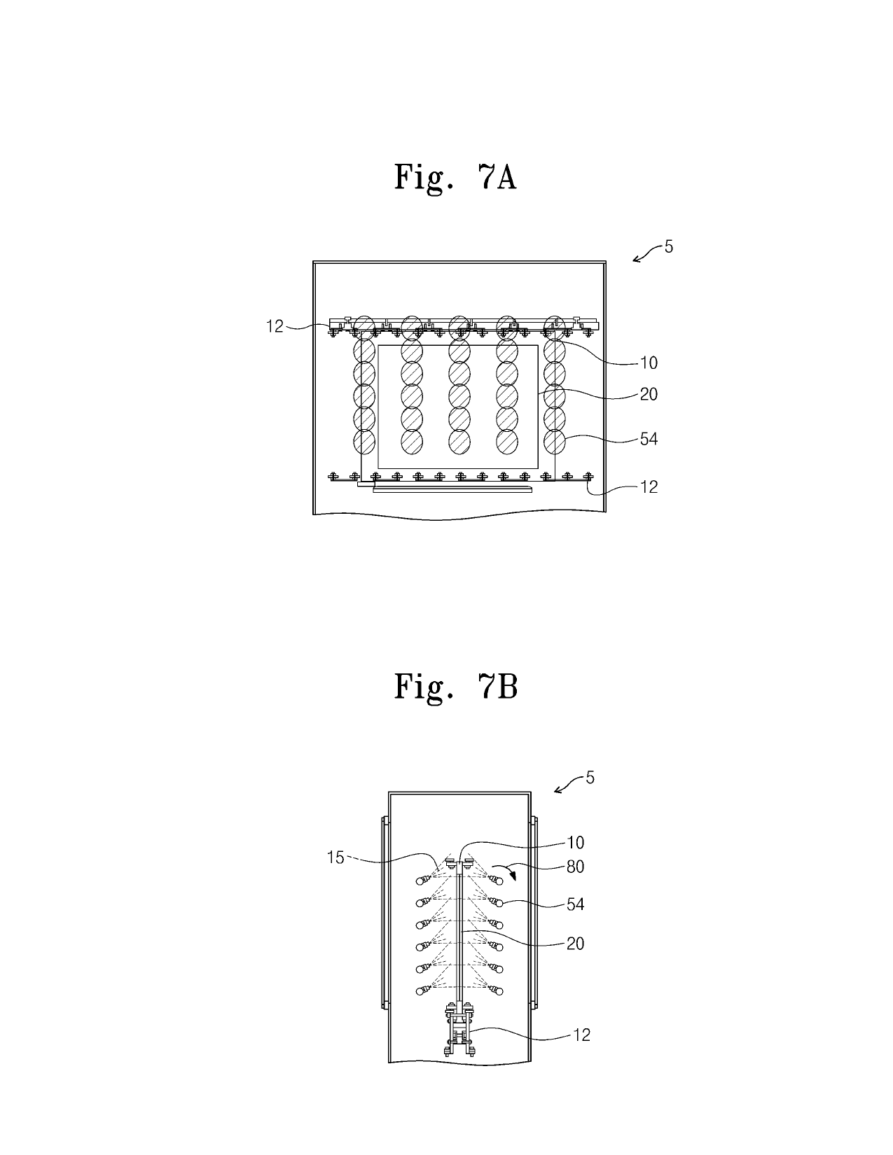

FIGS. 4A, 5A and 6A are side perspective views of an etching apparatus according to yet another alternative exemplary embodiment of the present invention. FIGS. 4B, 5B and 6B are partial cross-sectional side views of the etching apparatus according to the alternative exemplary of the present invention shown in FIGS. 4A, 5A and 6A, respectively.

Referring to FIGS. 4A to 6B, an etching apparatus 5 according to an alternative exemplary embodiment further includes a chamber 40. More specifically, the chamber 40 includes the jig 10 and the spray member 13 installed therein. In addition, the chamber 40 is connected to a driving part 42 by an arm 45 coupled between an uppercenter portion 41 of the chamber 40 and the driving part 42 with a coupling part 47. The arm 45 and the driving part 42 swing, e.g., move, the chamber 40 in a first direction 60 (FIG. 4B) and/or a second direction 65 (FIG. 6B) during the etching process, thereby rotating the chamber 40 in a first arc 70 and/or a second arc 75, respectively.

As a result of swinging the chamber 40 during etching, the etchant is uniformly applied to a surface of the glass substrates 20. In addition, the etchant is applied to a “dead zone” between the nozzles of the spray member, thereby uniformly etching the surface of the glass substrates 20. Further, the etchant 15 is smoothly and uniformly applied to the surface of the glass substrates 20, and an etch rate is thereby enhanced in the etching apparatus 5 according to an exemplary embodiment.

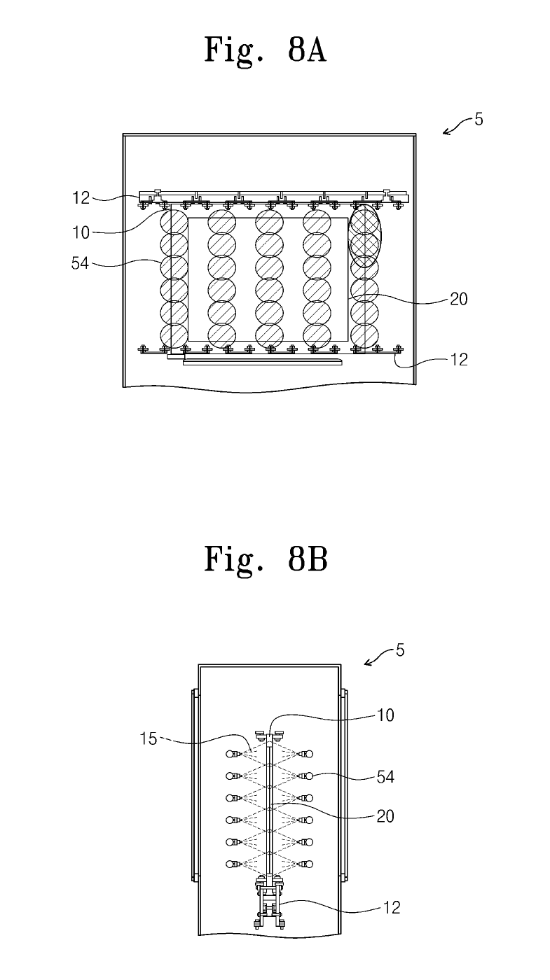

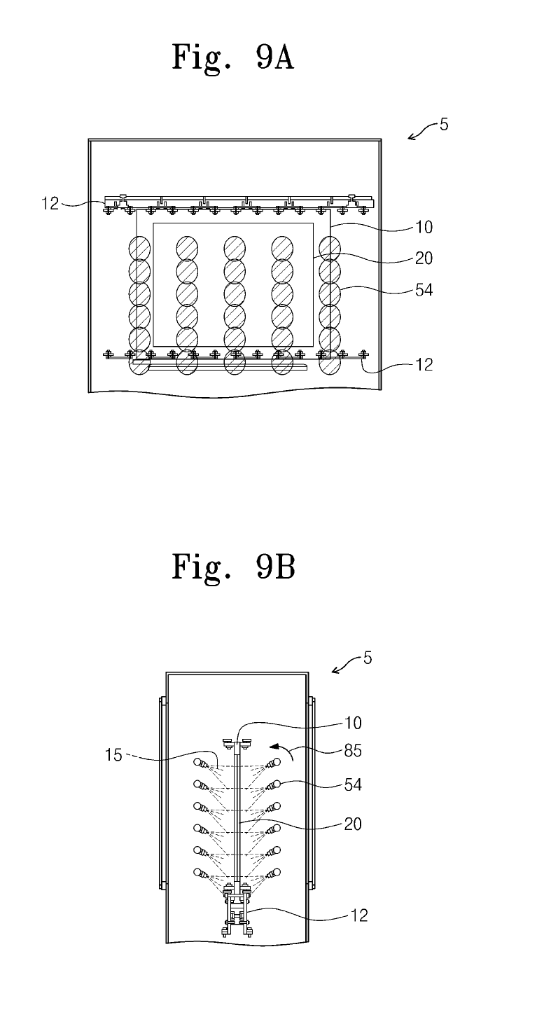

FIGS. 7A, 8A and 9A are side perspective views of an etching apparatus according to still another alternative exemplary embodiment of the present invention. FIGS. 7B, 8B and 9B are partial cross-sectional side views of the etching apparatus according to the alternative exemplary of the present invention shown in FIGS. 7A, 8A and 9A, respectively.

Referring to FIGS. 7A to 9B, in an etching apparatus 5 according to an exemplary embodiment, includes nozzles 54 as a spray member which are rotated during an etching process. In an exemplary embodiment, the nozzles 54 are rotated in a clockwise direction 80, as shown in FIG. 7B. In an alternative exemplary embodiment, the nozzles 54 are rotated in a counter clockwise direction 85, as shown in FIG. 9B, but alternative exemplary embodiments are not limited thereto. For example, in an alternative exemplary embodiment of the present invention, the nozzles 54 may be alternately rotated in the both the clockwise direction 80 and the counter clockwise direction 85 during the etching process. Therefore, when the nozzles 54 are rotated in the clockwise direction 80 and/or the counter clockwise direction 85, the etchant 15 is sufficiently and uniformly applied to regions of the glass substrates 20 between the nozzles 53, thereby uniformly etching a surface of the glass substrates 20.

When a distance between the nozzle 54 and the glass substrates 20 is shorter than approximately 100 mm, a force of the etchant 15 applied to the glass substrates 20 by the nozzle 54 is strong, and regions of the glass substrates 20 to which the etchant 15 is directly applied are etched differently, e.g., are etched to different thicknesses, than regions of the glass substrates 20 to which the etchant 15 is not directly applied, e.g., is applied with less force. Thus, in an exemplary embodiment, a distance between the nozzle 54 and the glass substrates 20 is in a range of approximately 100 mm to approximately 150 mm. In an alternative exemplary embodiment, a distance between the nozzle 54 and the glass substrates 20 is approximately 120 mm.

When a spray pressure of the etchant 15 from the nozzle 54 13 is equal to or greater than approximately 0.5 kg/cm², an etching reaction between the etchant 15 and the glass substrates 20 does not occur, since a flow rate of the etchant based upon the spray pressure is too fast. Thus, in an exemplary embodiment, the spray pressure of the etchant 15 is maintained at less than approximately 0.5 kg/cm².

Further, when the etch process is performed using a method in which the glass substrates 20 are dipped into an etch solution, or where a flow rate of the etchant 15 is otherwise low, the etch solution 15 becomes contaminated with residue, and the residue is subsequently applied to the glass substrates. Consequently, in an exemplary embodiment, the spray pressure of the etchant 15 from the spray member 13 is maintained greater than or equal to approximately 0.1 kg/cm² to maintain a sufficient flow of the etchant 15 such that contaminants are not deposited on the glass substrates 20.

As described herein, an etching apparatus according to exemplary embodiments of the present invention has advantages including, but not limited to, a capability to simultaneously etch more than one glass substrate, so that an etching time of the glass substrates for a flat panel display having the same is substantially reduced and/or effectively minimized.

Also, in an exemplary embodiment, a spray member and/or the glass substrates are swung, e.g., moved, while etching the glass substrates, and an etchant may thereby be uniformly applied to an entire surface of the glass substrates, thereby improving a uniformity of the glass substrates.

Further, in an exemplary embodiment, a spray pressure of the etchant from a spray member is maintained lower than approximately 0.5 kg/cm² and a distance between the glass substrates and the spray member is in a range of approximately 100 mm to approximately 150 mm, and the glass substrates may therefore be uniformly etched. The present invention should not be construed as being limited to the exemplary embodiments set forth herein. Rather, these exemplary embodiments are provided so that this disclosure will be thorough and complete and will fully convey the concept of the present invention to those skilled in the art

While the present invention has been particularly shown and described with reference to exemplary embodiments thereof, it will be understood by those of ordinary skill in the art that various changes in form and details may be made therein without departing from the spirit or scope of the present invention as defined by the following claims.

What is claimed is:

1. An etching apparatus of a glass substrate for a flat panel display, the etching apparatus comprising:
an etching chamber;
a jig at which plural glass substrates are settled;
a holding member connected to the jig to hold the glass substrates;
a transferring line connected to the jig to transfer the jig into the etching chamber; and
a spray member which sprays an etchant onto surfaces of the glass substrates,
wherein a spray pressure of the etchant is equal to or greater than approximately 0.1 kg/cm² and is less than approximately 0.5 kg/cm².

2. The etching apparatus of claim 1, wherein the spray member is disposed in the etching chamber.

3. The etching apparatus of claim 2, further comprising a driving part connected to the etching chamber to move the etching chamber.

4. The etching apparatus of claim 1, wherein the spray member comprises a nozzle which rotates in at least one of a clockwise direction and a counter clockwise direction.

5. The etching apparatus of claim 1, wherein the etchant comprises one of a fluoric acid, a phosphoric acid and a nitric acid.

6. The etching apparatus of claim 1, wherein a distance between the spray member and the glass substrates is greater than approximately 100 mm and is equal to or less than approximately 150 mm.

7. The etching apparatus of claim 1, wherein the holding member comprises:
a rear holding pin connected to a rear surface of at least one of the glass substrates; and
a rotatable front holding pin connected to a front surface of the at least one of the glass substrates.

8. The etching apparatus of claim 7, wherein the rotatable front holding pin comprises a structure which is at least one of detachable from the holding member and attachable to the holding member.

9. The etching apparatus of claim 1, wherein a distance between the spray member and the glass substrates is approximately 120 mm.

10. A method of etching a glass substrate for a flat panel display, the method comprising:
configuring an etching chamber to receive a jig;
disposing glass substrates on the jig;
connecting a holding member to the jig to hold the glass substrates;
transferring the jig into the etching chamber with a transferring line connected to the jig; and
spraying an etchant onto surfaces of the glass substrates with a spray member,
wherein a spray pressure of the etchant is equal to or greater than approximately 0.1 kg/cm² and is less than approximately 0.5 kg/cm².

11. The method of claim 10, wherein the spraying the etchant onto the surfaces of the glass substrates comprises rotating a nozzle in at least one of a clockwise direction and a counter clockwise direction.

12. The method of claim 10 further comprising:
connecting a driving part to the etching chamber; and
moving the etching chamber with the driving part.

13. The method of claim 10, wherein a distance between the spray member and the glass substrates is greater than approximately 100 mm and is equal to or less than approximately 150 mm.

14. The method of claim 10, wherein a distance between the spray member and the glass substrates is approximately 120 mm.

15. The method of claim 10, wherein the etchant comprises one of a fluoric acid, a phosphoric acid and a nitric acid.
